(19) United States
(12) Patent Application Publication
(10) Pub. No.: US 2013/0148522 A1
(43) Pub. Date: Jun. 13, 2013

(54) DATA COMMUNICATION APPARATUS AND METHOD THEREOF, AND DATA COMMUNICATION SYSTEM WITH THE SAME APPARATUS AND METHOD THEREOF

(71) Applicants: Ok Sun PARK, Daejeon (KR); Nam Il KIM, Daejeon (KR); Hyun Gu HWANG, Daejeon (KR); Dae Ho KIM, Daejeon (KR)

(72) Inventors: Ok Sun PARK, Daejeon (KR); Nam Il KIM, Daejeon (KR); Hyun Gu HWANG, Daejeon (KR); Dae Ho KIM, Daejeon (KR)

(73) Assignee: Electronics and Telecommunications Research Institute, Daejeon (KR)

(21) Appl. No.: 13/555,580

(22) Filed: Jul. 23, 2012

(30) Foreign Application Priority Data
Dec. 7, 2011 (KR) 10-2011-0130583

(51) Int. Cl. H04W 72/08; H04W 60/00; H04W 56/00; H04W 24/02; H04W 4/04

(52) U.S. Cl. 370/252; 370/328

(57) ABSTRACT

A data communication apparatus according to the present invention includes a channel determination unit for determining frequency channels to be monitored on the basis of a current location of the ship station, a performance measurement unit for measuring channel performance for each of the determined frequency channels, a channel selection unit for selecting one frequency channel from among the determined frequency channels on the basis of the measured channel performance, and a data communication unit for performing data communication with the coast station using the selected frequency channel.

### CROSS-REFERENCE TO RELATED APPLICATIONS

This application claims priority to and the benefit of Korean Patent Application No. 10-2011-0130583 filed in the Korean Intellectual Property Office on Dec. 7, 2011, the entire contents of which are incorporated herein by reference.

### TECHNICAL FIELD

The present invention relates to a data communication apparatus included in a ship station for data communication with a coast station and a data communication method thereof. The present invention relates to a data communication system in which an Internet service provider (ISP) performs data communication with the ship station via the coast station and a data communication method thereof.

### BACKGROUND ART

Maritime communication systems using a very high-frequency (VHF) band in the related art are analog communication systems focusing on voice communication at a channel bandwidth of 25 kHz. However, these communication systems have some problems in that frequency efficiency is low and a call processing function or encryption function is not provided.

As demand for e-mail and data communication in the maritime has increased in recent years, digital data communication schemes are being proposed to increase the data rate and also the capacity of all frequency bands. A digital VHF maritime data communication system may have a channel bandwidth greater than the system of the related art and use higher order modulation schemes. Accordingly, a data receiver in a ship station is required to have a structure in which the communication range thereof may be expanded. However, a data receiver selects a channel to be monitored on the basis of the location thereof; if there is a plurality of channels to be monitored, the data receiver cannot select an optimal channel from among the plurality of channels.

### SUMMARY OF THE INVENTION

The present invention has been made in an effort to provide a data communication apparatus and method and a data communication system and method for measuring channel performance for each of a plurality of channels to be monitored and then selecting an optimal channel for data communication from among the plurality of channels.

An exemplary embodiment of the present invention provides a data communication apparatus including a channel determination unit for determining frequency channels to be monitored on the basis of a current location of a ship station; a performance measurement unit for measuring channel performance for each of the determined frequency channels; a channel selection unit for selecting one frequency channel from among the determined frequency channels on the basis of the measured channel performance; and a data communication unit for performing data communication with a coast station using the selected frequency channel.

The data communication apparatus may further include an antenna control unit for controlling an antenna to be used for data transmission or reception according to whether there exists data to be transmitted to the coast station. The channel determination unit may determine the frequency channels to be monitored when the antenna is controlled to be used for data reception.

The data communication apparatus may be built in the ship station, the channel determination unit may acquire the current location through GPS, or the channel determination unit may use pre-acquired frequency plans together with the current location so as to determine the frequency channels to be monitored. The channel determination unit may select any one frequency plan from among the pre-acquired frequency plans on the basis of the current location acquired through GPS and use the frequency plan so as to determine the frequency channels to be monitored.

The performance measurement unit may measure a signal strength and a signal to noise ratio as the channel performance.

Another exemplary embodiment of the present invention provides a data communication system including a ship station location unit for locating a ship station when a data packet to be delivered to the ship station is generated; a coast station search unit for searching for a coast station located at the shortest distance from the searched current location on the basis of the searched current location; and a first information transmission unit for transmitting an identifier of the ship station; an identifier of the searched coast station; and the data packet to the ship station via the searched coast station.

The data communication system may further include a second information transmission unit for requesting reception of the data packet on the basis of the received identifier of the ship station when the identifier of the ship station and the data packet are received on the basis of the identifier of the searched coast station; a communication channel activation unit for activating a communication channel for data communication with the coast station when the request is received; and a data communication unit for performing data communication with the coast station to receive the identifier of the ship station; the identifier of the searched coast station; and the data packet when the communication channel is activated.

The communication channel activation unit may include a frame synchronization unit for performing frame synchronization on the basis of synchronization information received from the coast station during a predetermined first time period; a registration request unit for requesting registration on the basis of the synchronization information and system information received from the coast station; a response message interpretation unit for interpreting a response message to the request when the response message is received; and a second time period based channel activation unit for activating a communication channel for data communication with the coast station for each second time period designated by the coast station when the registration request is approved as the result of the interpretation.

The data communication unit may include a channel determination unit for determining frequency channels to be monitored on the basis of the current location; a performance measurement unit for measuring channel performance for each of the determined frequency channels; a channel selection unit for selecting one frequency channel from among the determined frequency channels on the basis of the measured channel performance; and a channel based data communication unit for performing the data communication with the coast station using the selected frequency channel.

Yet another exemplary embodiment of the present invention provides a data communication method including a channel determination step of determining frequency channels to be monitored on the basis of a current location of a ship station; a performance measurement step of measuring channel performance for each of the determined frequency channels; a channel selection step of selecting one frequency channel from among the determined frequency channels on the basis of the measured channel performance; and a data communication step of performing data communication with a coast station using the selected frequency channel.

The data communication method may further include an antenna control step of controlling an antenna to be used for data transmission or reception according to whether there exists data to be transmitted to the coast station. The channel determination step may determine the frequency channels to be monitored when the antenna is controlled to be used for data reception.

The channel determination step may acquire the current location through GPS or use pre-acquired frequency plans together with the current location so as to determine the frequency channel to be monitored. The channel determination step may select any one frequency plan from among the pre-acquired frequency plans on the basis of the current location acquired through GPS and use the frequency plan so as to determine the frequency channels to be monitored.

Still another exemplary embodiment of the present invention provides a data communication method including a ship station location step of locating a ship station when a data packet to be delivered to the ship station is generated; a coast station searching step of searching for a coast station located at the shortest distance from the searched current location on the basis of the searched current location; and a first information transmission step of transmitting an identifier of the ship station; an identifier of the searched coast station; and the data packet to the ship station via the searched coast station.

The first information transmission step may include a second information transmission step of requesting reception of the data packet on the basis of the received identifier of the ship station when the identifier of the ship station and the data packet are received on the basis of the identifier of the searched coast station; a communication channel activation step of activating a communication channel for data communication with the coast station when the request is received; and a data communication step of performing data communication with the coast station to receive the identifier of the ship station; the identifier of the searched coast station; and the data packet when the communication channel is activated.

The communication channel activation step may include a frame synchronization step of performing frame synchronization on the basis of synchronization information received from the coast station during a predetermined first time period; a registration request step of requesting registration on the basis of the synchronization information and system information received from the coast station; a response message interpretation step of interpreting a response message to the request when the response message is received; and a second time period based channel activation step of activating a communication channels for data communication with the coast station for each second time period designated by the coast station when the registration request is approved as the result of the interpretation.

The data communication step may include a channel determination step of determining frequency channels to be monitored on the basis of the current location; a performance measurement step of measuring channel performance for each of the determined frequency channels; a channel selection step of selecting one frequency channel among the determined frequency channels on the basis of the measured channel performance; and a channel based data communication step of performing the data communication with the coast station using the selected frequency channel.

According to exemplary embodiments of the present invention, the following effects may be obtained. First, it is possible to measure channel performance for each of a plurality of channels to be monitored and then select an optimal channel for data communication from among the plurality of channels, thereby improving the quality of communication. Secondly, it is possible to establish a digital maritime data communication system for transmitting packet data over an HF band, the communication system having a wide channel bandwidth and using a high-order modulation scheme, thereby improving the capacity of system. Finally, it is possible to access the internet network without affecting systems in the related art, even in a moving ship within the distance of 120 km from the coast.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram showing a data communication apparatus according to an exemplary embodiment of the present invention.

FIG. 2 is a conceptual view of a maritime data communication system.

FIG. 3 is a block diagram showing a structure of a coast station configuring the maritime data communication system.

FIG. 4 is a block diagram showing a structure of a ship station configuring the maritime data communication system.

FIG. 5 is a flowchart illustrating a data communication method using the data communication apparatus according to the exemplary embodiment.

FIG. 6 is a block diagram showing a data communication system according to an exemplary embodiment of the present invention.

FIGS. 7A and 7B is a block diagram specifically showing an inner configuration of the data communication system shown in FIG. 6.

FIG. 8 is a diagram explaining an operating procedure of the maritime data communication system.

FIG. 9 is a flowchart illustrating a data communication method using the data communication system according to the exemplary embodiment.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. It should be noted that like reference numerals refer to like elements even when they are depicted in different drawings. Moreover, detailed descriptions related to well-known functions or configurations will be ruled out in order not to unnecessarily obscure subject matters of the present invention. Preferred embodiments of the present invention will be described below in more detail. However, the technical idea of the present invention is not limited thereto, and it will be apparent to those skilled in the art that various modifications and variations can be made in the present invention.

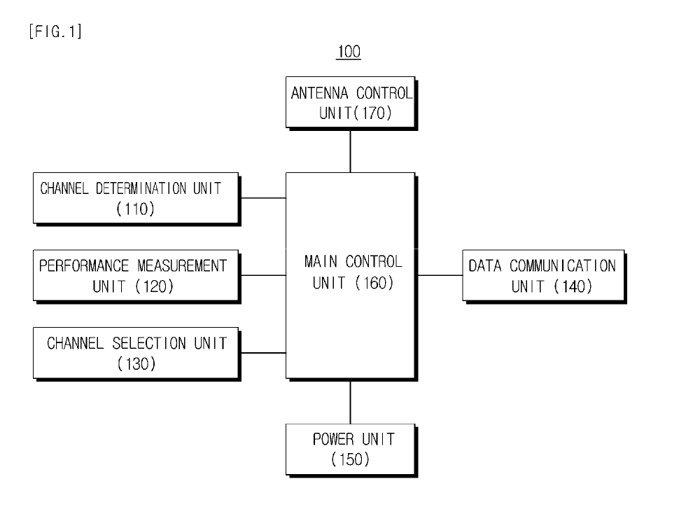

FIG. 1 is a block diagram showing a data communication apparatus according to an exemplary embodiment of the present invention. According to FIG. 1, the data communication apparatus 100 includes a channel determination unit 110, a performance measurement unit 120, a channel selection unit 130, a data communication unit 140, a power unit 150, and a main control unit 160. The data communication apparatus 100 may further include an antenna control unit 170.

The data communication unit 100 is a data transceiver, which is provided in a ship station.

The channel determination unit 110 determines frequency channels to be monitored on the basis of a current location. The channel determination unit 110 may acquire the current location from global positioning system (GPS). The channel determination unit 110 may use pre-acquired frequency plans together with the current location so as to determine the frequency channels to be monitored. The channel determination unit 110 may select any one frequency plan among the pre-acquired frequency plans on the basis of the current location acquired through GPS and use the frequency plan so as to determine the frequency channels to be monitored.

The performance measurement unit 120 measures channel performance for each of the determined frequency channels. The performance measurement unit 120 may measure a signal strength and a signal to noise ratio as the channel performance.

The channel selection unit 130 selects one frequency channel from among the determined frequency channels on the basis of the measured channel performance. The channel selection unit 130 may select a frequency channel having the strongest signal strength and the lowest signal to noise ratio. Alternatively, the channel selection unit 130 may select frequency channels having the signal to noise ratio lower than a reference value and then select a frequency channel having the strongest signal strength from among the frequency channels. Alternatively, the channel selection unit 130 may select frequency channels having the signal strength greater than a reference value and then select a frequency channel having the lowest signal to noise ratio from among the frequency channels.

The data communication unit 140 performs data communication with a coast station using the selected frequency channel.

The power unit 150 supplies power to each element constituting the data communication apparatus 100.

The main control unit 160 controls an entire operation of each element constituting the data communication apparatus 100.

The antenna control unit 170 controls an antenna to be used for data transmission or reception according to whether there exists data to be transmitted to the coast station. In this case, the channel determination unit 110 determines frequency channels to be monitored when the antenna is controlled to be used for data reception.

As demand for e-mail and data communication in the maritime increases, digital data communication schemes are being proposed to increase the data rate and also the capacity of any frequency band. The proposed VHF maritime data communication system additionally has channel bandwidths of 50 kHz and 100 kHz which are 2-4 times greater than that of the system in the related art and uses a high-order modulation scheme, thereby increasing a data transmission rate. The present invention proposes a structure of a transmitter and receiver suitable for the maritime communication system and a method of accessing the Internet network to exchange data.

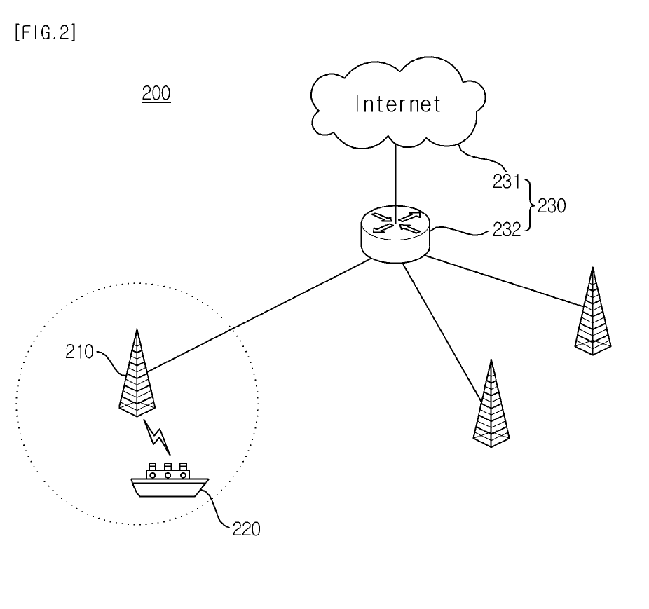

FIG. 2 is a conceptual view of a maritime data communication system. As shown in FIG. 2, a maritime VHF data communication system 200 includes a coast station (CS) 210 and a ship station (SS) 220. The SS 220 is defined as a VHF mobile communication apparatus equipped in a ship. The CS 210 is defined as a communication apparatus installed in a coast station to control the SS 220 and connected to a network over VHF band. The CS 210 may access a high-speed Internet network 231 and an application server 232 of an Internet service provider (ISP) 230.

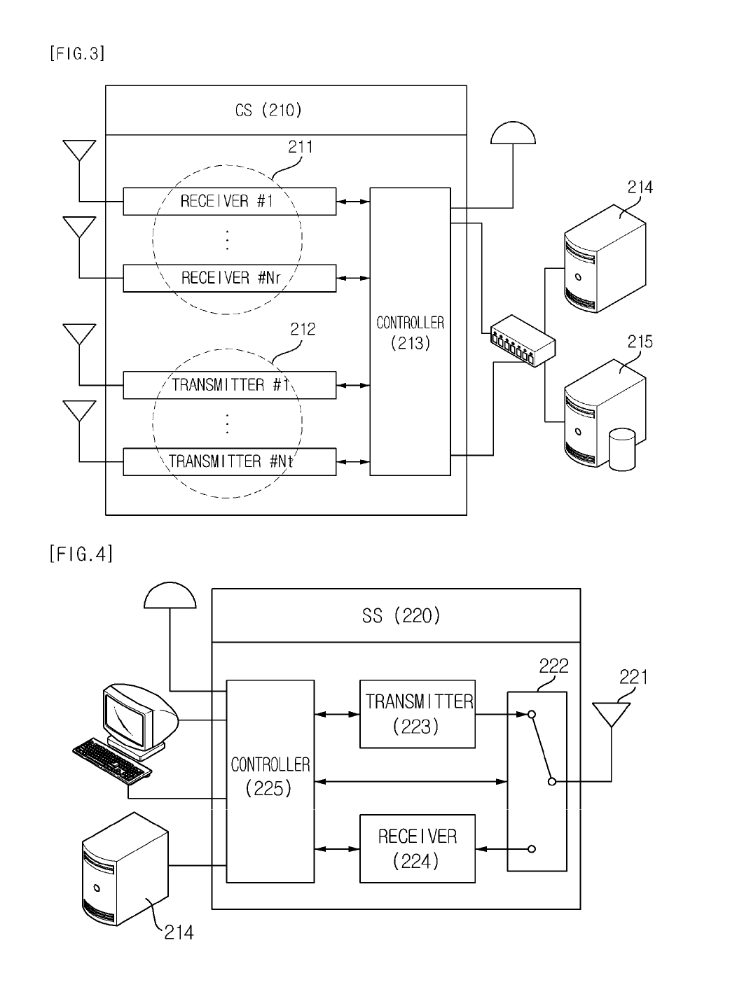

FIG. 3 illustrates a structure of the CS 210. The CS 210 includes a transmitter 212 and a receiver 211 separately so as to perform simultaneous processing of transmission and reception. The CS 210 may support up to M multiple channels.

The receiver 211 may process NR (1<NR<M) channels according to a traffic amount and then store the processed channels to a database server 215. The receiver 211 is required to be a multi-channel receiver which may have NR fixed frequency channels and perform simultaneous reception.

The transmitter 212 may process NT (1<NT<M) channels according to a traffic amount and then store the processed channels to the database server 215. The transmitter 212 is required to be a multi-channel transmitter which may have NT fixed frequency channels and perform simultaneous transmission.

The CS 210 additionally includes a controller 213, which identifies the SS 220 in a cell thereof and manages radio links and frequency channels. The controller 213 divides a packet into segments having a size appropriate for the radio link or sequentially combines received packets to deliver the divided or combined packet to a proxy server.

The CS 210 is connected to the Internet through a main server 214 and stores information on ships, which are registered in the CS 210, to the database server 215. A communication interface between the CS 210 and respective servers is Ethernet.

FIG. 4 illustrates a structure of the SS 220. Operating frequencies of a transmitter 223 and a receiver 224 of the SS 220 are different. However, transmission and reception are not performed simultaneously. This function is performed by a switch 222. Accordingly, a controller 225 of the SS 220 provides a control signal for switching between the transmitter 223 and the receiver 224 for each slot. Reference numeral 221 denotes an antenna.

The SS 220 receives only one of transmission frequency channels of the CS 210. Accordingly, if there exist a plurality of channels, the SS 220 needs to select an optimal channel. In the channel selection, the SS 220 selects a plurality of channels to be monitored with reference to frequency plans of respective countries stored in a database on the basis of a location of the SS 220 which is acquired with a GPS receiver of the SS 220. The SS 220 selects the optimal channel by measuring a reception signal level and signal to noise ratio for each channel.

The controller 225 identifies the CS 210, manages radio links and frequency channels, and divides a packet into segments of a size appropriate for the radio link, or combines received packets sequentially to deliver the divided or combined packet to a proxy server. A communication interface between the SS 220 and the main server 214 is Ethernet.

The SS 220 may be connected to a local network through a fixed internet protocol (IP) and Ethernet and to peripheral devices such as a monitor, keyboard, etc., using a standard IEC 61162.

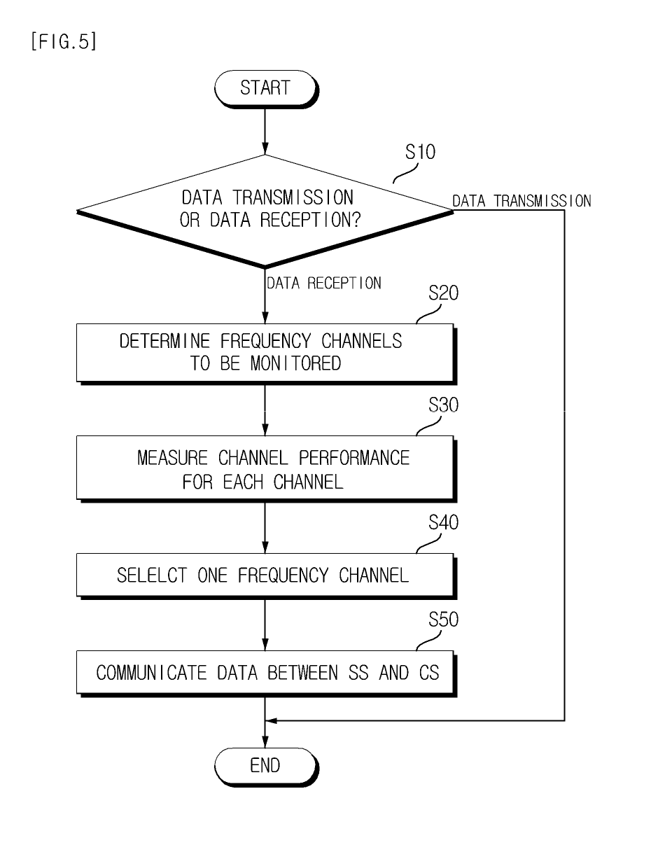

A data communication method using the data communication apparatus will be described below. FIG. 5 is a flowchart illustrating a data communication method using the data communication apparatus according to the exemplary embodiment. The following description will be made with reference to FIGS. 1 and 5.

Firstly, the channel determination unit 110 determines frequency channels to be monitored on the basis of a current location of the SS 220 (channel determination step S20). The channel determination unit 110 may acquire the current location of the SS 220 using GPS. The channel determination unit 110 may use pre-acquired frequency plans together with the current location so as to determine the frequency channels to be monitored. The channel determination unit 110 may select any one frequency plan among the pre-acquired frequency plans on the basis of the current location acquired through GPS and use the frequency plan so as to determine the frequency channels to be monitored.

After the channel determination step S20, the performance measurement unit 120 measures channel performance for each of the determined frequency channels (performance measurement step S30).

After the performance measurement step S30, the channel selection unit 130 selects one frequency channel from among frequency channels determined by the channel determination unit 110, on the basis of the measured channel performance (channel selection step S40). After the channel selection step S40, the data communication unit 140 performs data communication with the CS 210 using the selected frequency channel (data communication step S50).

Alternatively, before the channel determination step S20, an antenna control step S10 may be performed. This step S10 is performed by the antenna control unit 170. The antenna control unit controls an antenna to be used for data transmission or reception depending on whether there exists data to be transmitted to the CS 210. The channel determination unit 110 may determine frequency channels to be monitored when the antenna is controlled to be used for data reception.

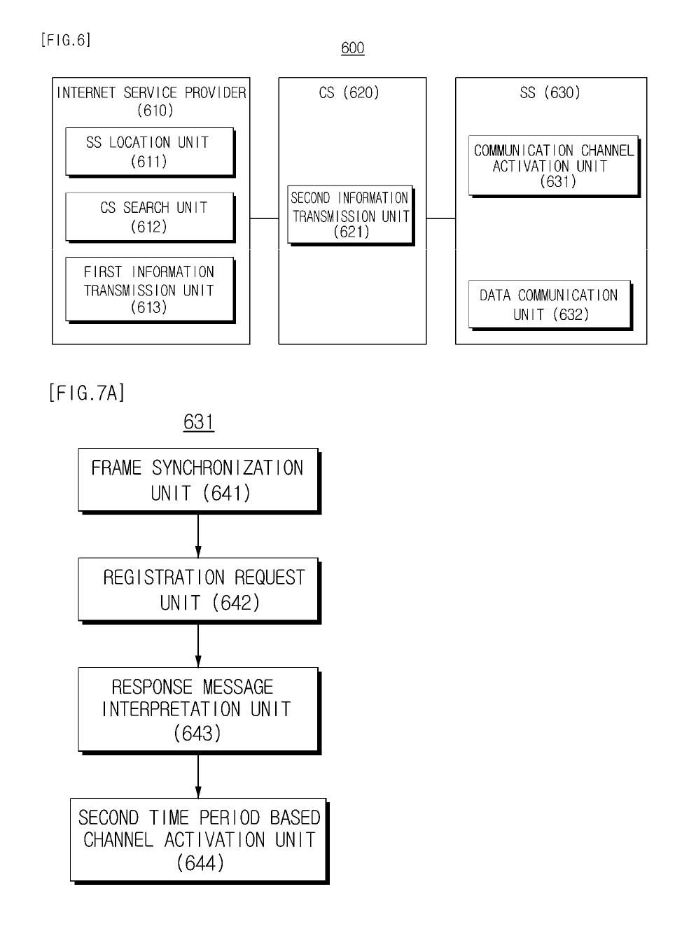

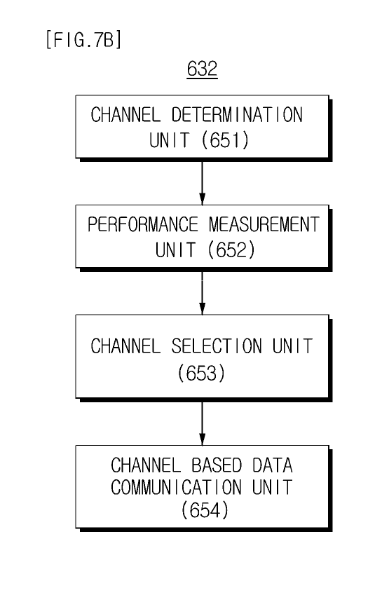

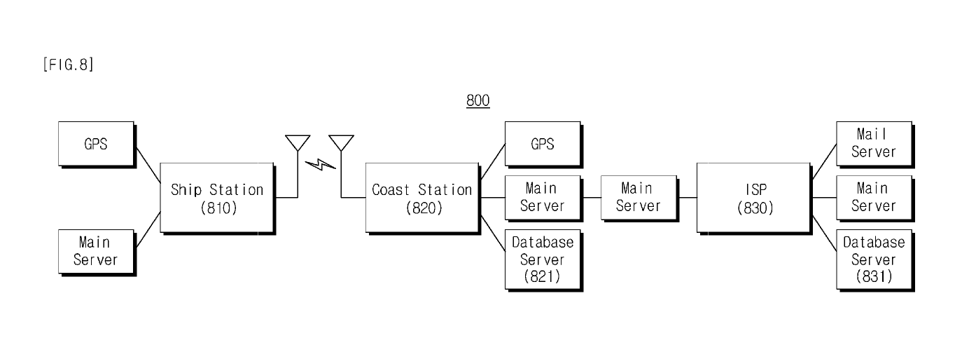

A data communication system including the data communication apparatus shown in FIG. 1 will be described below. FIG. 6 is a block diagram showing a data communication system according to an exemplary embodiment of the present invention. FIG. 7 is a block diagram specifically showing an inner configuration of the data communication system shown in FIG. 6. The following description will be made with reference to FIGS. 6 and 7.

According to FIG. 6, a data communication system 600 includes an Internet service provider (ISP) 600, a coast station (CS) 620, and a ship station (SS) 630. The ISP 610 includes an SS location unit 611, a CS search unit 612, and a first information transmission unit 613. The CS 620 includes a second information transmission unit 621. The SS 630 includes a communication channel activation unit 631 and a data communication unit 632.

When a data packet to be delivered to the SS 630 is generated, the SS location unit 611 locates the SS 630. The CS search unit 612 searches for the CS 620 located at the shortest distance from the searched current location on the basis of the searched current location of the SS 630.

The first information transmission unit 613 transmits an identifier of the SS 630, an identifier of the searched CS 620, and a data packet to the SS 630 via the searched CS 620.

When the data packet and the identifier of the SS 630 are received on the basis of the identifier of the searched CS 620, the second information transmission unit 621 transmits the data packet to the SS 630 on the basis of the received identifier of the SS 630.

The communication channel activation unit 631 activates a communication channel for data communication with the CS 620. As shown in FIG. 7A, the communication channel activation unit 631 may include a frame synchronization unit 641, a registration request unit 642, a response message interpretation unit 643, and a second time period-based channel activation unit 644.

The frame synchronization unit 641 performs frame synchronization on the basis of synchronization information received from the CS 620 during a predetermined first time period. In this case, the first time period means a control frame period selected in a multi-frame.

The frame synchronization unit 641 performs frame synchronization by controlling an uplink-to-downlink timing with an offset which is less than a frame length related to the first time period. The frame synchronization unit 631 uses slot information, frame information, and multi-frame information including the first time period as the synchronization information.

The registration request unit 642 requests registration on the basis of the synchronization information and system information received from the CS 620. The registration request unit 642 uses the identifier of the CS 620, slot information to be activated only during the first time period, and parameters related to a communication channel as the system information.

When a response message to the registration request is received, the response message interpretation unit 643 interprets the response message. The response message interpretation unit 643 receives approval or rejection of the registration request, the identifier of the CS 620, the identifier of the SS 630, and slot information related to a second time period as a response message. To sense a carrier in the communication channel, the response message interpretation unit 643 further receives parameters used to sense the carrier as the response message when a communication channel is activated.

The response message interpretation unit 643 may include an identifier determination unit and a determination result based message interpretation unit. When the response message is received, the identifier determination unit determines whether a destination identifier included in the response message is identical to the identifier of the SS 630. The determination result based message interpretation unit interprets the response message if the identifiers are identical as the result of the determination.

The second time period based channel activation unit 644 activates a communication channel for data communication with the CS 620 at every second time period designated by the CS 620 if the registration is approved as the result of the response message interpretation. In this case, the second time period means a slot period for data transmission selected in each frame.

The second time period based channel activation unit 644 activates a communication channel during the second time period. The sensing of a carrier in data transmission depends on parameter information acquired when the SS 630 receives the response to the registration request from the CS 620 after the registration request. The communication channel activation unit 644 uses a time period designated according to a result of monitoring a traffic amount for each time period and an equivalent distribution rule of a traffic amount for each time period, as the second time period.

The communication channel activation unit 641 may further include a message reception determination unit. The message reception determination unit determines whether the response message is received in a predetermined time. In this case, the registration request unit 642 requests the registration again if the response message is not received in the predetermined time. The message reception determination unit uses a value greater than the length of the multi-frame including the first time period, as the predetermined time.

The data communication unit 632 performs data communication with the CS 620 and receives the identifier of the SS 630, the identifier of the searched CS 620, and the data packet when the communication channel is activated. The data communication unit 632 may include a channel determination unit 651, a performance measurement unit 652, a channel selection unit 653, and a channel based data communication unit 654, as shown in FIG. 7B. Descriptions about the channel determination unit 651, the performance measurement unit 652, the channel selection unit 653, and the channel based data communication unit 654 were mentioned above with reference to FIG. 1 and thus will be omitted herein. The channel based data communication unit 654 means the data communication unit 140 of FIG. 1.

FIG. 8 is a diagram explaining an operating procedure of the maritime data communication system. The operation procedure of the system will be described with reference to FIG. 8.

An ISP 830 checks a final location of a SS 810 stored in a database server 831 when a packet to be delivered to the SS 810 is generated. When the ISP 830 delivers the packet to a CS 820 having a database 821 storing an identifier of the SS 810, the CS 820 generates and transmits a data message by adding a first destination identifier and first source identifier to the packet. The first destination identifier means the identifier of the SS 810, and the first source identifier means the identifier of the CS 820.

The SS 810 receives a synchronization signal from the CS 820 to acquire frame synchronization and system information. Then, when the SS 810 completes a registration procedure with the CS 820, the identifier and location of the SS 810 are stored in the database servers 821 and 831 of the CS 820 and the ISP 830, respectively. When a packet to be delivered is prepared, the SS 810 adds a second destination identifier and second source identifier to the packet to generate a data message and transmits the data message on the basis of the carrier sensing in a slot (channel) allocated in the registration procedure. The second destination identifier means the identifier of the CS 820, and the second source identifier means the identifier of the SS 810.

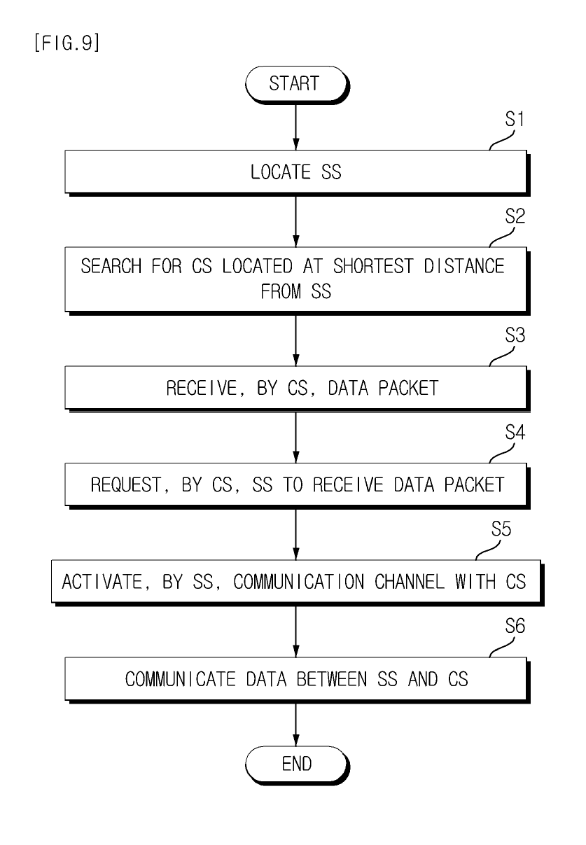

A data communication method using the data communication system will be described below. FIG. 9 is a flowchart illustrating a data communication method using the data communication system according to the exemplary embodiment of the present invention. The following description will be made with reference to FIGS. 6, 7, and 9.

Firstly, when the data packet to be delivered to the SS 630 is generated, the SS location unit 611 locates the SS 630 (SS location step, S1). Then, the CS search unit 612 searches for the CS 620 located at the shortest distance from the searched current location on the basis of the searched current location of the SS 630 (CS search step S2). The first information transmission unit 613 transmits the identifier of the SS 630, the identifier of the CS 620, and the data packet to the searched CS 620 (S3). When the identifier of the SS 630 and the data packet are received on the basis of the identifier of the searched CS 620, the second information transmission unit 621 requests the reception of the data packet on the basis of the received identifier of the SS 630 (second information transmission step S4). When the request is received, the communication channel activation unit 631 activates communication channel for data communication with the CS 620 (communication channel activation step S5). When the communication channel is activated, the data communication unit 632 performs data communication with the CS 620 and receives the identifier of the SS 630, the identifier of the searched CS 620, and the data packet (data communication step S6).

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A data communication apparatus comprising:
a channel determination unit for determining frequency channels to be monitored on the basis of a current location;
a performance measurement unit for measuring channel performance for each of the determined frequency channels;
a channel selection unit for selecting one frequency channel from among the determined frequency channels on the basis of the measured channel performance; and
a data communication unit for performing data communication with a coast station using the selected frequency channel.

2. The data communication apparatus of claim 1, further comprising an antenna control unit for controlling an antenna to be used for data transmission or reception according to whether there exists data to be transmitted to the coast station,
wherein the channel determination unit determines the frequency channels to be monitored when the antenna is controlled to be used for data reception.

3. The data communication apparatus of claim 1,
wherein the data communication apparatus is built in a ship station, the channel determination unit acquires the current location through GPS, or the channel determination unit uses pre-acquired frequency plans together with the current location so as to determine the frequency channels to be monitored.

4. The data communication apparatus of claim 3, wherein the channel determination unit selects any one frequency plan from among the pre-acquired frequency plans on the basis of the current location acquired through GPS and uses the frequency plan so as to determine the frequency channels to be monitored.

5. The data communication apparatus of claim 1, wherein the performance measurement unit measures a signal strength and a signal to noise ratio as the channel performance.

6. A data communication system comprising:
a ship station location unit for locating a ship station when a data packet to be delivered to the ship station is generated;
a coast station search unit for searching for a coast station located at the shortest distance from the searched current location on the basis of the searched current location; and
a first information transmission unit for transmitting an identifier of the ship station, an identifier of the searched coast station, and the data packet to the ship station via the searched coast station.

7. The data communication system of claim 6, further comprising:
a second information transmission unit for transmitting the data packet on the basis of the received identifier of the ship station when the identifier of the ship station and the data packet are received on the basis of the identifier of the searched coast station;
a communication channel activation unit for activating a communication channel for data communication with the coast station during a predetermined time period; and
a data communication unit for performing data communication with the coast station to receive the identifier of the ship station, the identifier of the searched coast station, and the data packet when the communication channel is activated.

8. The data communication system of claim 7, wherein the communication channel activation unit comprises:
a frame synchronization unit for performing frame synchronization on the basis of synchronization information received from the coast station during a predetermined first time period;
a registration request unit for requesting registration on the basis of the synchronization information and system information received from the coast station;
a response message interpretation unit for interpreting a response message to the request when the response message is received; and
a second time period based channel activation unit for activating a communication channel for data communication with the coast station for each second time period designated by the coast station when the registration request is approved as the result of the interpretation.

9. The data communication system of claim 7, wherein the data communication unit comprises:
a channel determination unit for determining frequency channels to be monitored on the basis of the current location of the ship station;
a performance measurement unit for measuring channel performance for each of the determined frequency channels;
a channel selection unit for selecting one frequency channel among the determined frequency channels on the basis of the measured channel performance; and
a channel based data communication unit for performing the data communication with the coast station using the selected frequency channel.

10. A data communication method comprising:
a channel determination step of determining frequency channels to be monitored on the basis of a current location;
a performance measurement step of measuring channel performance for each of the determined frequency channels;
a channel selection step of selecting one frequency channel from among the determined frequency channels on the basis of the measured channel performance; and
a data communication step of performing data communication with a coast station using the selected frequency channel.

11. The data communication method of claim 10, further comprising:
an antenna control step of controlling an antenna to be used for data transmission or reception according to whether there exists data to be transmitted to the coast station,
wherein the channel determination step determines the frequency channels to be monitored when the antenna is controlled to be used for data reception.

12. The data communication method of claim 10, wherein the channel determination step acquires the current location through GPS or uses pre-acquired frequency plans together with the current location so as to determine the frequency channel to be monitored, and
the channel determination step selects any one frequency plan from among the pre-acquired frequency plans on the basis of the current location acquired through GPS and uses the frequency plan so as to determine the frequency channels to be monitored.

13. A data communication method comprising:
a ship station location step of locating a ship station when a data packet to be delivered to the ship station is generated;
a coast station search step of searching for a coast station located at the shortest distance from the searched current location on the basis of the searched current location; and
a first information transmission step of transmitting an identifier of the ship station, an identifier of the searched coast station, and the data packet to the ship station via the searched coast station.

14. The data communication method of claim 13, wherein the first information transmission step comprises:
a second information transmission step of transmitting the data packet on the basis of the received identifier of the ship station when the identifier of the ship station and the data packet are received on the basis of the identifier of the searched coast station;
a communication channel activation step of activating a communication channel for data communication with the coast station during a predetermined time period; and
a data communication step of performing data communication with the coast station to receive the identifier of the ship station, the identifier of the searched coast station, and the data packet when the communication channel is activated.

15. The data communication method of claim 14, wherein the communication channel activation step comprises:
a frame synchronization step of performing frame synchronization on the basis of synchronization information received from the coast station during a predetermined first time period;
a registration request step of requesting registration on the basis of the synchronization information and system information received from the coast station;
a response message interpretation step of interpreting a response message to the request when the response message is received; and
a second time period based channel activation step of activating a communication channel for data communication with the coast station for each second time period designated by the coast station when the registration request is approved as the result of the interpretation.

16. The data communication method of claim 14, wherein the data communication step comprises:
a channel determination step of determining frequency channels to be monitored on the basis of the current location;
a performance measurement step of measuring channel performance for each of the determined frequency channels;
a channel selection step of selecting one frequency channel from among the determined frequency channels on the basis of the measured channel performance; and
a channel based data communication step of performing the data communication with the coast station using the selected frequency channel.
